(19) United States
(12) Patent Application Publication
(10) Pub. No.: US 2026/0090566 A1
(43) Pub. Date: Apr. 2, 2026

(54) METHOD AND FORMULATION FOR IMPROVED SHELF-STABILITY OF STARCH-BASED FOODS USING POLYPHENOLS

(71) Applicant: The Stardust Food Company, Bethesda, MD (US)

(72) Inventors: Mika Shino, Bethesda, MD (US); Kjetil Hansen, Bethesda, MD (US)

(21) Appl. No.: 18/903,850

(22) Filed: Oct. 1, 2024

(51) Int. Cl. A23G 3/42; A21D 2/18; A21D 2/36; A21D 8/06; A21D 13/80; A23G 3/34; A23G 3/48; A23L 3/3472; A23L 3/3544; A23L 7/109

(52) U.S. Cl. CPC A23G 3/42; A21D 2/186; A21D 2/36; A21D 8/06; A21D 13/80; A23B 2/733; A23B 2/771; A23G 3/0021; A23G 3/48; A23L 7/109

(57) ABSTRACT

A method and formulation for improvement in at least the texture and shelf stability of starch-based foods is disclosed, such as but not limited to gummy candies, through the incorporation of polyphenols, wherein said polyphenols may include but are not limited to one or more of flavonoids, phenolic acids, lignans, stilbenes, and tannins. This method and formulation comprises the use of polyphenol molecules to improve and stabilize starch-based foods for extended periods of time without the use of artificial preservatives. The method and formulation including one or more polyphenols also allows utilization of specific beneficial qualities of the polyphenols including: flavor, aroma, color and the numerous associated health benefits. Thus, the method and formulation facilitates the production of various starch-based foods (e.g., chewy candies, mochi, breads, cakes, pastas, etc.) with unique and previously unattainable qualities that are advantageous for consumer-packaged foods.

### BACKGROUND

The present invention is relates to a method and formulation for improvement in at least the texture and shelf stability of starch-based foods, such as but not limited to gummy candies, through the incorporation of polyphenols, wherein said polyphenols may include but are not limited to one or more of flavonoids, phenolic acids, lignans, stilbenes, and tannins.

Shelf-stable, starch-based foods have remained a challenge to formulate, particularly those having a comparatively soft texture, long shelf life, and are organic and/or natural, animal-free, healthful, and flavorful. Due to at least staling or hardening and mold growth, typical starch-based foods have a limited shelf-life (bread, cakes, donuts, etc.) or in the case of starch-based candies often have a tough bite and short chew (e.g., Twizzlers®, Red Vines®, Swedish Fish®). Traditional gummy candies such as gummy bears often use gelatin to provide the familiar bite, chew and shelf-stability required as a consumer-packaged food. However, gelatin is an animal byproduct ordinarily produced by the hydrolysis of collagen obtained from the connective tissue of animals such as cattle, chicken, pigs, or fish, and is a major constraint for those who prefer plant-based diets due to personal or religious reasons. Other artificial ingredients used to enhance texture and extend shelf stability include: sodium benzoate, potassium sorbate, isopropyl alcohol, propylene glycol, among others, with many having questionable health effects.

Even with the use of these artificial ingredients, chewy candies made from a starch become hard, chalky, or brittle when kept at room temperature for extended periods, similar to other starch-based foods such as bread and cakes. Of course, this is an issue in retail sales where products must remain on a shelf for a long time at room temperature. Thus, instead of the soft bouncy texture of gelatin-based gummy bears, traditional starch-based candies are often hard, with a tough bite and shorter chew (e.g., Twizzlers®, Red Vines®, Swedish Fish®). This hardening of starch-based candies is due to a process called retrogradation, where the amylose and amylopectin components of gelatinized starch reorganize into a more crystalline structure over time.

The present invention attempts to solve these problems as well as others.

### SUMMARY OF THE INVENTION

Provided herein are methods and formulations comprising the use of polyphenol molecules to stabilize starch gelatinization to minimize retrogradation and preserve the texture and chew of starch-based foods without the need for artificial preservatives or animal products.

The methods and formulations are set forth in part in the description which follows, and in part will be obvious from the description, or can be learned by practice of the methods and formulations. The advantages of the methods and formulations will be realized and attained by means of the elements and combinations particularly pointed out in the appended claims. It is to be understood that both the foregoing general description and the following detailed description are exemplary and explanatory only and are not restrictive of the methods and formulations, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1 is a graph showing the viscosity measurement of starch in an excess amount of water, applying a temperature profile including a heating and cooling step. (1) Gelatinization onset (TP, pasting temperature), (2) hydration of starch granules, (3) max. intensity of gelatinization (PV, peak viscosity), (4) enzymatic and shear destruction of starch granules, (5) minimum viscosity (HPV, hot paste viscosity), (6) viscosity loss (B, breakdown), (7) final viscosity (FV), and (8) paste hardening (S, setback). [1]

FIG. 2 is a schematic of the chemical structure showing the hydrogen bonding between water and starch molecule. [2]

FIG. 3 is a schematic of the molecular structure of polyphenol classes. [3]

FIG. 4 is a schematic of the chemical structures of compounds in the flavonoid class. [4]

FIG. 5 is a schematic of a scraped surface heat exchanger. [9]

FIG. 6 is a schematic of a single screw cooker/extruder. [10]

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### DESCRIPTION OF EMBODIMENTS

The method and formulation comprises the novel use of polyphenol molecules in the formulation of starch-based foods to improve and maintain the food's texture and chewing experience over an extended time, with decreased and/or controlled staling, hardening, or mold growth. Thus, this method and formulation comprises a shelf-stable, starch-based food product without the need for artificial preservatives such as sorbic acid, sodium benzoate, calcium propionate, sulfites, among others commonly used in the industry and include the use of a stabilizer, in one embodiment. The method and formulation comprises the beneficial functional properties of polyphenols including flavor, aroma, and numerous health benefits through their incorporation into starch-based food products. The method and formulation comprises a variety of starches, such as but not limited to rice, tapioca, arrowroot, corn, potato, taro, and wheat, and a number of starch-based foods, such as but not limited to chewy candies, breads, cakes, cookies, chips, pasta and noodles through the incorporation of polyphenol compounds into the formulation. Thus, this method and formulation allows for an improved eating experience for the consumer without the need for artificial preservative ingredients, providing value for numerous consumer packaged foods.

As described herein, an unexpected stabilizing interaction forms between polyphenol molecules and various starches that results in a soft and fluffy texture that is unique among starch-based candies and is preserved (e.g., stable) over time due to decreased staling or retrogradation, thereby improving shelf life. The method and formulation comprises a variety of starches, such as but not limited to rice, tapioca, arrowroot, corn, potato, taro, and wheat, and a number of starch-based foods, such as but not limited to chewy candies, breads, cakes, cookies, chips, pasta, and noodles through the incorporation of polyphenol compounds into the formulation. Thus, this method and formulation provides an improved eating experience for the consumer without the need for artificial preservative ingredients, providing value for numerous consumer packaged foods. The method and formulation significantly improves duration of storage without degradation, something further beneficial for the consumer as well as any distributors or sales agents.

The formulation of starch-based foods comprises polyphenol molecules (e.g., flavonoids, phenolic acids, lignans, stilbenes, and tannins) to produce at least a unique texture and chewing experience that is self-sustainable for longer periods of time than in the prior art, with decreased staling or molding, as compared with traditional starch-based recipes that do not use artificial preservatives or stabilizers. In one embodiment, the method comprises creating such food products, including both the products themselves as well as methodologies for creating such products, where the products include one or more said polyphenols. In the descriptions below, references are made to formulations and figures which form a part hereof. By way of illustration, a specific embodiment is disclosed, in which the invention may be practiced. It is to be understood that other embodiments maybe utilized, and changes to the formulation or manufacturing process may be made without departing from the scope or intent of the present invention.

In a preferred embodiment, at least one or more starches is combined with one or more polyphenols to produce a soft chewy candy with a room temperature shelf-life of at least 6 months and is further void of and animal products and byproducts. In one embodiment, a method of creating and preserving a unique texture and chewiness of starch-based chewy candy comprising: using a low molecular weight carbohydrate-based compound to improve starch gelatinization of the starch-based chewy candy and decreasing the starch retrogradation to produce a shelf-stable food product with a soft and chewy texture. The low molecular weight carbohydrate-based compound molecule is polyol like glycerin, sorbitol, erythritol, xylitol, mannitol, allulose, dextrose, fructose, or other polyol molecules.

In order to formulate a sustained soft chew, starch-based chewy candy, we introduce polyphenol molecules as an ingredient into the formulation, with a goal being, at least in part, to improve gelatinization and reduce retrogradation of starches (e.g., rice, tapioca, arrowroot, corn, potato, taro, and wheat), without introducing animal-based gelatin or gelatin-related products. The incorporation of polyphenol molecules, using the methodology of the present invention, into starch-based candy formulations produces a surprising soft bouncy texture with a long pleasant chew that is unique and novel among traditional starch-based chewy candies. After extensive testing of hundreds of formulations, we discovered that the combination of polyphenol molecules to these starches had an unexpected interaction with one or more starches to substantially improve the preservation of this texture over time (6-12 months) without the end product becoming hard, chalky, brittle, or moldy. In comparison, formulations without the use of polyphenols, gelatin, or artificial preservatives, became stale, hard and inedible within a few days. Thus, this invention allows for the production of shelf-stable starch-based chewy candies without the use of gelatin or artificial preservatives that are commonly found in contemporary chewy candies.

### Starch Gelatinization:

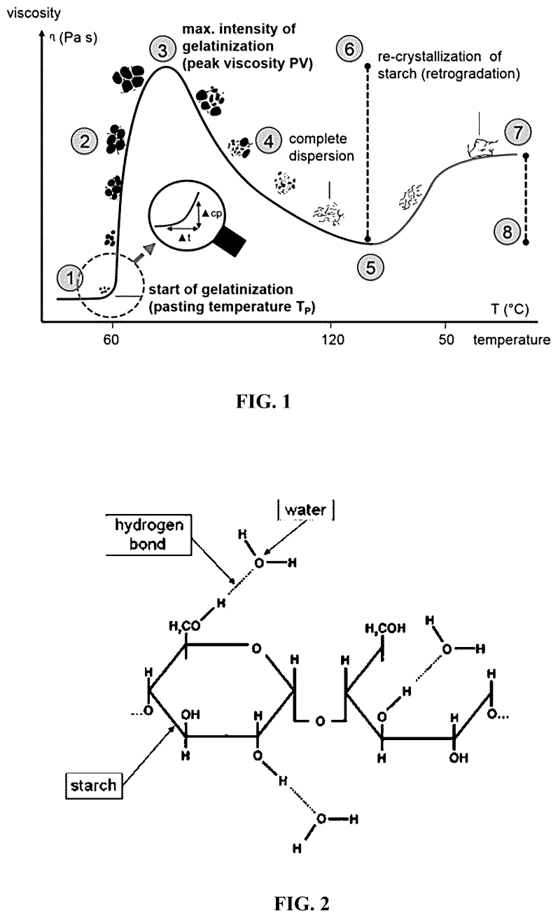

Starch gelatinization is the process of disrupting intermolecular bonds of starch molecules in the presence of water and heat, allowing the hydrogen bonding sites (i.e., the hydroxyl hydrogen and oxygen atoms) of the starch to engage with more water. This leads to: 1) starch granule swelling, 2) disruption of starch double helical structures, and 3) starch granule rupture (FIG. 2). Gelatinized starch, when cooled or stored for a long enough period (hours to days) will harden and rearrange itself again to a more crystalline structure in a process known as retrogradation. This reorganization or retrogradation is the major factor leading to the hard, chalky, or brittle characteristics that most starches develop when kept even for a few hours at room temperature.

The extent and timing of starch gelatinization and retrogradation is dependent on a number of factors including the starch properties, water content, and cooking conditions. In particular, the water-to-starch ratio is critical due to its strong effect on the extent of both gelatinization and retrogradation. Due to water's ability to engage with starch hydrogen bonding sites and disrupt the intermolecular order of the starch, higher water-to-starch ratios increase gelatinization and decrease retrogradation. This is crucially important for the production of shelf-stable starch-based consumer packaged food products since it requires tightly controlled gelatinization and retrogradation. Importantly, the water content of the final product must be maintained below strict levels to ensure protection against the growth of bacteria and mold.

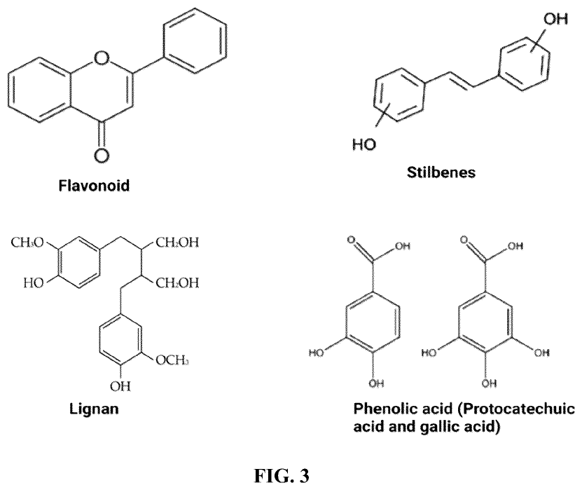

After extensive testing of hundreds of ingredients and formulations, the polyphenols have a surprising and unexpected interaction with starches to improve gelatinization, delay retrogradation, and inhibits bacterial and mold growth. Incorporation of polyphenols also substantially improved the chewy texture of starch candies and this unique chew remains preserved over months without becoming hard, chalky, or brittle. This unique chew and texture preservation occurs through the hydroxyl groups on the polyphenol molecules. These polyphenol hydroxyl groups are available for bonding (e.g., hydrogen bonding) with starch molecules (FIG. 3). The polyphenols with their hydroxyl groups disrupt starch to starch intramolecular and intermolecular bonding and decrease recrystallization and retrogradation of the starch. In one embodiment, polyphenols are able to decrease starch retrogradation without increasing the water content or activity of the final product, which allows for the production of a shelf-stable starch-based candy with a unique and elastic chew that is preserved for months without becoming hard or chalky, and protecting against bacterial and mold growth (since it does not affect water content).

In one embodiment, % Retrogradation can be measured by Differential scanning calorimetry (DSC) as indicated below. Typical retrogradation rates after 2 weeks are 30-40% for unmodified starch. For modified starches, the retrogradation rates are less than 20%.

The modified starches may be close to typical for unmodified starches and the retrogradation rates are between about 25% and about 35%.

Retrogradation continues to increase over time and is affected by the amount of initial gelatinization and well as other ingredients present, which can inhibit the retrogradation. So retrogradation would continue to increase if measured monthly over the shelf life of a starch candy food product.

Other ways to measure retrogradation include the following:
1) When examining the gelatinization processes by temperature scanning calorimetric measurements (e.g., DSC), up to 4 thermal transitions can be observed depending on the water content and final heating temperature (Goldstein and others 2010; Randzio and others 2002):
2) A single endotherm, generally referred to as the G endotherm, occurring at ˜60-70° C. in excess water (usually >50% wet basis). This endotherm, if present, occurs at constant temperature regardless of the amount of water present in the system. The enthalpy change increases with increasing water content.
3) A second endothermic peak, commonly called the M1 endotherm, may partially overlap the G endotherm and is observed at higher temperatures as the starch to water ratio increases. As water content is sufficiently increased, the G and M1 endotherm converge, resulting in a single endothermic peak as previously described.
4) As water content further decreases, the G endotherm disappears, and the M1 endotherm shifts to higher temperatures.
5) Two transitions, occurring at temperatures higher than the G and M1 endotherms have also been observed and are typically linked to the melting of amylose and amylose-lipid complexes.

In one embodiment, a thick paste with the modified starches and show no retrogradation and compare it to the mochi gummy candy and show retrogradation.

Differential scanning calorimetry (DSC) is a thermoanalytical technique in which the difference in the amount of heat required to increase the temperature of a sample and reference is measured as a function of temperature. DSC can measure retrogradation includes the following steps: 3.7 mg of starch (or mochi dry mix) weighed into 25 ul aluminum pans; add distilled water added at a ratio 3:1; sealed pan set overnight at room temperature; heat in DSC from 25° C. to 100° C. at a rate of 10° C./min; and % retrogradation calculated as the ratio of enthalpy of gelatinization to enthalpy of retrogradation.

### Polyphenols:

Polyphenols are organic compounds characterized by a “polyphenol structure” made of one or more hydroxyl (—OH) groups on aromatic rings. Polyphenols are found abundantly in plants including fruits, vegetables, grains, seeds, nuts, cocoa, tea, coffee, and wine, and additionally contribute to the colors and flavors of these foods. Polyphenols are individually classified on the basis of the number of phenol rings that they contain and the structural elements that bind these rings together. Polyphenols are broadly divided into four classes: flavonoids, phenolic acid, stilbenes, and lignans, as shown in FIG. 3.

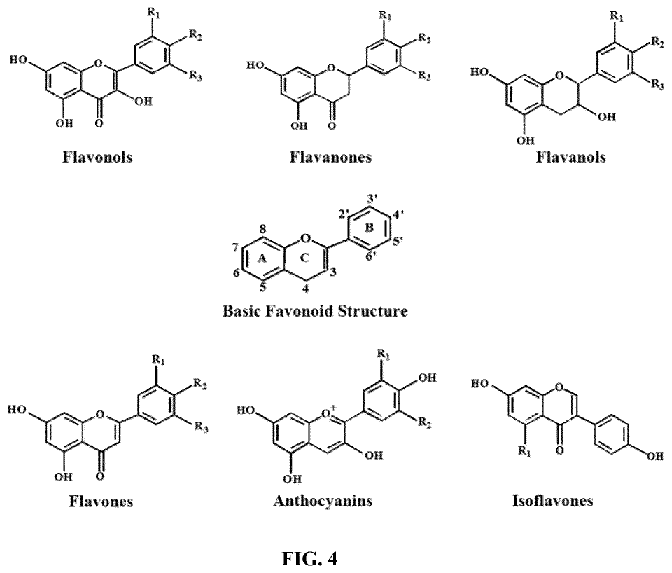

Flavonoids are the largest group of polyphenols and characterized by two phenyl rings linked by a heterocyclic pyrone ring, as shown in FIG. 4. Flavonoids include compounds such as but not limited to quercetin, anthocyanins, and chalcones, commonly found in fruits, vegetables, and teas. Each of these flavonoids, and polyphenols in general, have a distinct flavor and color profiles [Table 1]. Quercetin is slightly bitter, with a pale-yellow color; Anthocyanins is tart with a red to purple color; Chalcones can be mildly sweet with an orange to red color. Phenolic acids, stilbenes, and lignans are the major groups of non-flavonoid polyphenols. Phenolic acids are characterized by the presence of a carboxylic acid group and phenol group and include compounds such as hydroxybenzoic acid and caffeic acid, and are also found in fruits, vegetables and teas. Phenolic acids can have a bitter to complex flavor and are colorless to pale yellow in color. Stilbenes are characterized by two phenyl groups connected by an ethylene bridge and include resveratrol, commonly found in grapes, red wine and peanuts. Stilbenes have a mild, slightly bitter flavor and are colorless. Lignans have 1,4-diarylbutane in their structure and include compounds such as pinoresinol and matairesinol. Lignans can have a mild nutty flavor and is colorless to brown in color.

TABLE 1
Summary of Polyphenol Molecules
Polyphenol Molecules

| | | | | Antimicrobial |
|---|---|---|---|---|
| Name | Flavor | Color | Found in: | Properties |
| Quercetin | Slightly bitter | Pale yellow | Onions, apples and kale | Yes |
| Kaempferol | Slightly bitter | Pale yellow | Kale, beans, tea, spinach, and | |
| | | | broccoli | |
| Myricetrin | Bitter and astringent | Yellow to green | Berries, grapes, walnuts | |
| Catechins | Astringent | Colorless | Tea, apples | Yes |
| Anthocyanins | Tart | Red, purple or blue | Berries, red cabbage, eggplants | Yes |
| Isoflavones | Mild, slightly bitter | Colorless to pale yellow | Soy, legumes, chickpeas | |
| Hesperidin | Bitter | Colorless to pale yellow | Oranges and lemons | |
| Chalcones | Bitter, mild sweetness | Orange, red, deep orange | Apples, strawberries, legumes | Yes |
| Stilbenes | Mild, slightly bitter | Colorless | Grapes, red wine, berries, | Yes |
| | | | peanuts | |
| Lignans | Mild, nutty | Colorless, tan, brown | Flaxseed, sunflower seed, | Yes |
| | | | sesame seeds | |
| Phenolic | Astringent, bitter, | Colorless to pale yellow | Berries, apples, citrus, carrots, | Yes |
| acid | complexity. | | tomatos | |

Polyphenols are noted to have numerous health benefits including: antioxidant properties, anti-inflammatory effects, cardiovascular health, brain health, cancer prevention, weight management, and antimicrobial effects.

Antioxidant Properties: Polyphenols are potent antioxidants that can neutralize harmful free radicals that cause oxidative stress/damage and have been linked with various disease including cancer and cardiovascular disease. [5]

Anti-Inflammatory Effects: Polyphenols have been shown to have anti-inflammatory properties that may be helpful in chronic inflammatory diseases including arthritis, diabetes, and cancer. [6]

Cardiovascular Health: Polyphenols, particularly the flavonoids, have been linked to cardiovascular health with improvement in blood pressure, lipid metabolism and blood coagulation. [7]

Brain Health: Polyphenols may have neuroprotective effects and could help prevent age-related cognitive decline and neurodegenerative diseases such as Alzheimer's and Parkinson's diseases. [8]

Cancer Prevention: Polyphenols may have anti-cancer effects including prevention of tumor formation, inhibition of tumor growth, induction of cell death or apoptosis. [9]

Weight Management: Studies suggest that polyphenols may aid in weight management and obesity prevention. Polyphenols are thought to modulate metabolic processes including: energy expenditure, fat oxidation, and appetite regulation. [3]

Antimicrobial Effects: Polyphenols have been shown to have both anti-bacterial and anti-fungal properties. [10]

Thus, polyphenols can be selected to enhance certain characteristics of the final product including flavor, color, antimicrobial properties, and specific health benefits. For example, Myricetrin can be added to green grape flavored gummy candy to enhance the texture, shelf-stability, green color and bitter flavor. Lignans can be added to caramel flavored candies to enhance the texture, shelf-stability, tan color, nutty flavor and anti-microbial properties. Hesperidin can be used to enhance the texture, shelf-stability, bitter citrus flavor and yellow color of lemon-flavored candies. Colorless phenolic acids can be added to enhance the texture, shelf-stability, flavor and anti-microbial properties of candies that are light in color such as vanilla.

These polyphenols can be incorporated into starch-based foods through several methods including: 1) As an extract, concentrate, juice or powder obtained from the source fruit, vegetable, nut, seed or legume (e.g. lemon juice concentrate, lemon peel extract, berry juice concentrate, etc.), 2) As a purified form of the specific polyphenols (e.g. quercetin, catechin, hesperidin concentrate powder).

For example, cocoa is abundant in polyphenols including flavanols, procyanidins, and epicatechin. Matcha tea contains polyphenols found in green tea including catechins, epigallocatechin gallate, epicatechins, and catechin gallates. Citrus fruits are rich in flavanones (e.g., hesperidin, naringin), flavonols (e.g., quercetin, kaempferol), catechin, epicatechin, limonoids, phenolic acids, and anthocyanins. These polyphenols are found in the peel, pulp, and juice of citrus fruits. Berries are rich in anthocyanins, flavonols, ellagitannins, flavonols, hydroxycinnamic acids, and procyanidins. Pomegranates are rich in ellagitannins, anthocyanins, flavonols, flavanols and tannins. Green leafy vegetables such as kale and broccoli are excellent sources of polyphenols including flavonoids, phenolic acid, lutein, and zeaxathin. Nuts such as almonds and walnuts contain flavonoids, ellagic acid, tannins, phenolic acid and resveratrol. Thus, the addition of cocoa powder to a chocolate candy, matcha powder to a matcha flavored candy, lemon or lemon peel concentrate to a lemon candy would allow us to enhance the flavor, color, aroma, texture, shelf-life and health benefits of the candy.

Alternatively, polyphenols can be extracted from the source plant and purified through various methods. One method involves drying and grinding of the source plant (fruit, vegetable, nut, legume, etc.), the dried powder is mixed with a solvent (e.g., water, methanol, ethanol, etc.) to extract the polyphenol, and the mixture is filtered to remove the plant debris, leaving a crude extract containing the polyphenols. The polyphenols are then purified though methods including: rotary evaporation, liquid-liquid extraction, solid-phase extraction or column chromatography [11]. Thus, instead of using cocoa powder, matcha powder, or lemon peel concentrate as an example, purified quercetin, catechin, anthocyanins, or lignans etc. can be used to enhance specific characteristics of the candy such as texture, shelf-life, flavor, color, antimicrobial or health benefits.

Polyphenols and purified polyphenol concentrates can also be incorporated individually or in combination into starch-based recipes. For example, instead of artificial mango flavoring, gelatin, and propylene glycol, purified quercetin, kaempferol and catechin extracted from the mango fruit, can be combined with mangiferin and gallic acid from the mango peel to produce shelf-stable starch-based “mango” candy with a unique and unexpectedly pleasant flavor, color and chew. Similarly, polyphenol concentrates extracted from pomegranate juice, fruit, seeds and peel can be used to produce an all-natural and unique shelf-stable chewy “pomegranate” candy without artificial ingredients. As another example, the polyphenols contained in cocoa powder can be combined with purified lignans extracted from flaxseeds to produce a soft dark brown starch-based candy with a nutty cocoa flavor that is shelf-stable with enhanced antimicrobial properties.

In one embodiment of the method and formulation, a gummy candy is prepared for shelf-stable distribution by combining one or more polyphenols with one or more starches, such as a tapioca-based starch, and processed together to create the desired characteristics including: texture, chew, color, flavor, aroma, shelf-stability, anti-microbial properties, as well as selected health benefits.

The interaction between polyphenols and different starches and starch combinations were tested, including rice, tapioca, arrowroot, corn, potato, taro, and wheat. The addition of polyphenols to these starches and starch combinations enhanced the texture, chew and shelf-life of the resulting starch-based candies. For example, the addition of cocoa or matcha to tapioca, rice or taro starch produced a silky and creamy texture that was preserved for more than 2 years without substantial retrogradation or staling. The addition of citrus and pomegranate polyphenols to tapioca, rice, taro or arrowroot starch produced a fluffy and marshmallow-like texture that was similarly preserved for over 6 months.

The ways to measure softness, bounce, bite, chew, and stability of the food product include texture profile analysis, which uses a machine like the TAXT2 from Stable Microsytems. Texture profile analysis compress the sample 40%, releases the pressure, compress the sample 40% again. The procedure first press is hardness, ratio of distance to max firmness for each compression is chewiness, amount of pull back is stickiness (adhesiveness), area underneath the second compression curve divided by the area underneath the first compression curve is cohesiveness, resilience (elasticity) ratio of the area of the curves. Normal starch candy is cohesive, sticky (adhesive) and not elastic, and the current starch gel embodiments are less sticky and more elastic. A TPA analysis on both will show an increase in elasticity and decrease in stickiness of the starch-based food products of the present invention.

Starch is made from amylose and amylopectin which add to =100% starch. Tapioca is about 17% amylose and about 85% amylopectin. Rice: short grain is about 24% amylose, about 76% amylopectin. Dent Corn starch is about 27% amylose, and about 73% amylopectin. High Amylose corn starch: used in confections industry to increase gelling is between about 55 to about 70% amylose. Potato Starch is about 20% amylose and about 80% amylopectin. A method for measuring amylose content is disclosed in “A Simplified Chemical Method for Determining Classes of Rice Amylose Content which Control Cooked Rice Texture” by Dr. Ming-Hsuan Chen at USDA Agricultural Research Service.

Trials were conducted evaluating numerous production methods and the methods which utilized heat, mechanical stress, and pressure surprisingly and substantially improved the texture and chew of the product, producing a soft and bouncy candy with long elastic chew. The long term (between about 3 to about 6 months) staling trials demonstrated decreased retrogradation or staling. In addition to heat, pressure improves hydration of the starch granules, while mechanical shear improves starch granule disruption. Thus, both pressure and shear increase the disorder of the starch molecule, leading to improved gelatinization and decreased retrogradation.

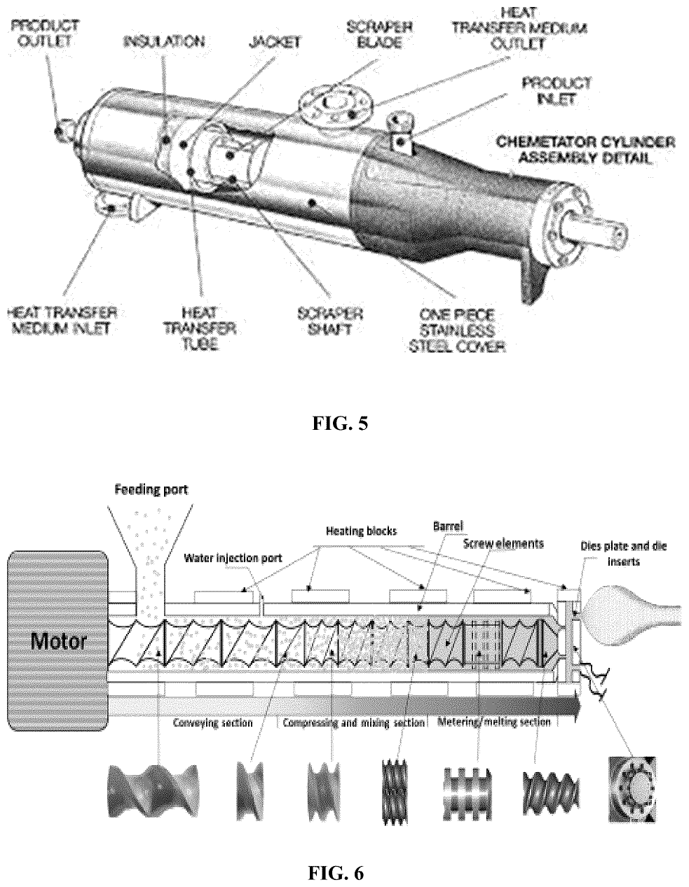

Mechanical stress and pressure can be added to the manufacturing system through the use of: A pressurized scraped surface heat exchanger (FIG. 5), or single or twin-screw cooking extruder (FIG. 6).

Manufacturing Process may include some or all of the following steps: 1) Use of starch combinations (modified vs. unmodified rice, tapioca, taro, arrowroot, corn, and potato) and polyphenols to achieve desired texture, chew and shelf-stability. 2) Add all ingredients including: starches, polyphenols, saccharides, water, etc. 3) Temperature cooking from 160 C to 260 C. 4) Mechanical stress and pressure (0-10 bars) applied by scraped surface heat exchanger or single/twin screw cooker extruder. 5) Introduce acids and buffers (weak acids) such as but not limited to citric acid, malic acid, cultured dextrose, and cultured brown rice to enhance flavor and achieve target pH between about 2.5 to about 6.8 to inhibit bacterial/fungal growth.

Besides candy formulations, in other embodiments, polyphenols can be incorporated into other starch recipes, including, but not limited to, breads, cakes, cookies, donuts, chips, crackers, pretzels, cereals, rice cakes, mochi, boba, pasta and noodles to enhance the texture, chew, taste, color and to gain functional benefits, and the method and formulation includes such combinations.

Thus, the method and formulation comprise a starch-based (e.g., rice, tapioca, arrowroot, corn, potato, taro, and/or wheat) food with the incorporation of polyphenol compounds between about 1% and about 30% by weight. These formulations may comprise other ingredients such as water, saccharides (candy, cakes, cookies, etc.), yeast (bread), eggs (pastas), herbs, spices, artificial or natural flavors and colors, or various acids, among other ingredients.

Certain embodiments of the method and formulation include the following:
1) Starches and flours (modified/unmodified) from rice, tapioca, arrowroot, corn, potato, taro and wheat.
2) The use of one or more polyphenol compounds between 1% to 30%.
3) The use of monosaccharides/disaccharides/oligosaccharides/polysaccharides: glucose, fructose, allulose, sucrose, dextrose, brown sugar, brown sugar, soluble corn fiber, soluble tapioca fiber, polydextrose, polyol syrups, corn syrup, tapioca syrup, glucose syrups.
4) Other ingredients including yeast, eggs, butter and oil.
5) Herbs and spices.
6) Other flavoring including natural and artificial flavors.
7) Coloring including natural and artificial colors.
8) Acids: Citric acid, malic acid, cultured dextrose, cultured brown rice.

Polyphenols compounds may be obtained as an extract from the leaves, roots, bark, peel, seed, pulp, or juice one of more of the following sources: cocoa, matcha, citrus (lemon, orange, grapefruit), pomegranate, grape, berries (strawberry, blueberry, raspberry, blackberry, cranberries, goji, acai, elderberries, currants, cherries), plums, prunes, kiwi, pears, apricots, acai, vegetables (kale, swiss chard, tomatoes, onions, garlic, broccoli, cauliflower, bell pepper, artichokes, eggplant), legumes (soy, lentils, chickpeas, black beans, kidney beans), nuts and seeds (almonds, walnuts, pistachios, pecans, flaxseeds, chia seeds, sesame seeds), herbs and spices (cloves, cinnamon, oregano, rosemary, thyme, sage, turmeric, ginger, dark chocolate), and beverages (green tea, black tea, coffee, red wine). These polyphenols may be used as raw unpurified extracts from the roots, bark, peel, seed, pulp or juice of the source plant. They may also be used as purified compounds after an extraction and purification process. These polyphenols and purified polyphenol concentrates can be used individually or in combination to attain the desired qualities of the starch-based food.

Certain embodiments of the invention may have the following formulations and percentages based upon weight (although not all ingredients may be included in some further embodiments):

Tapioca-based Candy Formulation

| | |
|---|---|
| Modified tapioca starch | between about 5 to about 40% |
| Tapioca flour | between about 5 to about 40% |
| Polyphenols | between about 1 to about 30% |
| Tapioca or glucose syrup | between about 10 to about 50% |
| Sugar (Cane or other) | between about 10 to about 50% |
| Invert sugar | between about 10 to about 50% |
| Flavoring | between about 0.5 to about 10% |
| Coloring | between about 0.5- to about 10% |
| Acid | between about 0.1 to about 5% |
| Water | between about 5 to about 30% |
| Other ingredients | between about 1 to about 30% |

Rice-based Candy Formulation

| | |
|---|---|
| Modified Rice Starch | between about 5 to about 40% |
| Rice Starch | between about 5 to about 40% |
| Polyphenols | between about 1 to about 30% |
| Tapioca or glucose syrup | between about 10 to about 50% |
| Sugar (Cane or other) | between about 10 to about 50% |
| Invert sugar | between about 10 to about 50% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

Tapioca and Rice-based Candy Formulation

| | |
|---|---|
| Modified tapioca starch | between about 5 to about 40% |
| Tapioca flour | between about 5 to about 40% |
| Modified Rice Starch | between about 5 to about 40% |
| Rice Starch | between about 5 to about 40% |
| Polyphenols | between about 1 to about 30% |
| Tapioca or glucose syrup | between about 10 to about 50% |
| Sugar (Cane or other) | between about 10 to about 50% |
| Invert sugar | between about 10 to about 50% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

Multi-Starch Candy Formulation

| | |
|---|---|
| Starch modified or unmodified (rice, | between about 5 to about40% |
| tapioca, arrowroot, corn, potato, | |
| taro, and wheat) | |
| Polyphenols | between about 1 to about30% |
| Tapioca or glucose syrup | between about 10 to about50% |
| Sugar (Cane or other) | between about 10 to about50% |
| Invert sugar | between about 10 to about50% |
| Flavoring | between about 0.5 to about10% |
| Coloring | between about 0.5 to about 10% |
| Acid | between about 0.1 to about 5% |
| Water | between about 5 to about 30% |
| Other ingredients | between about 1 to about 30% |

Mochi Formulation

| | |
|---|---|
| Sweet/glutinous rice flour | between about 5 to about50% |
| Polyphenols | between about 1 to about 30% |
| Sugar (Cane or other) | between about 10 to about 50% |
| Tapioca Syrup | between about 10 to about 50% |
| Invert sugar | between about 10 to about 50% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

Bread/Bagel Formulation

| | |
|---|---|
| Starch modified or unmodified (rice, | between about 40 to about 90% |
| tapioca, arrowroot, corn, potato, | |
| taro, and wheat) | |
| Yeast | between about 1 to about 5% |
| Polyphenols | between about 1 to about 30% |
| Sugar (Cane or other) | between about 1 to about5% |
| Water | between about 5 to about 30% |
| Other ingredients | between about 1 to about 30% |

Cake/Donut Formulation

| | |
|---|---|
| Starch modified or unmodified (rice, | between about 30 to about70% |
| tapioca, arrowroot, corn, potato, | |
| taro, and wheat) | |
| Polyphenols | between about 1 to about 30% |
| Sugar (Cane or other) | between about 5 to about 40% |
| Milk (cow's, almond, soy etc.) | between about 2 to about 20% |
| Egg | between about 2 to about 20% |
| Butter | between about 5 to about 20% |
| Flavoring (e.g. vanilla extract) | between about 1 to about 5% |
| Baking powder or soda | between about 1 to about 5% |
| Other ingredients | between about 1 to about 30% |

Cookie Formulation

| | |
|---|---|
| Starch modified or unmodified (rice, | between about 30 to about 60% |
| tapioca, arrowroot, corn, potato, | |
| taro, and wheat) | |
| Polyphenols | between about 1 to about 30% |
| Sugar (Cane or other) | between about 5 to about 40% |
| Egg | between about 2 to about 20% |
| Butter | between about 5 to about 20% |
| Flavoring (e.g. vanilla extract) | between about 1 to about 5% |
| Baking powder or soda | between about 1 to about 5% |
| Other ingredients | between about 1 to about 30% |

Formula 7: Pasta/Noodle Formulation

| | |
|---|---|
| Starch modified or unmodified (rice, | between about 40 to about 90% |
| tapioca, arrowroot, corn, potato, | |
| taro, and wheat) | |
| Polyphenols | between about 1 to about 30% |
| Egg | between about 2 to about 20% |
| Other ingredients | between about 1 to about 40% |

Formula 8: Chips/Pretzels/Cereal Formulation

| | |
|---|---|
| Starch modified or unmodified (rice, | between about 40 to about 90% |
| tapioca, arrowroot, corn, potato, | |
| taro, and wheat) | |
| Polyphenols | between about 1 to about 30% |
| Sugar (Cane or other) | between about 2-40% |
| Yeast | between about 0.01 to about 2% |
| Water | between about 5 to about 40% |
| Butter | between about 2 to about 10% |
| Other ingredients | between about 1 to about 40% |

In conclusion, the method for improving the texture and shelf-stability of starch-based foods comprising incorporation of polyphenol compounds. A surprising and unexpected interaction between starches (e.g., rice, tapioca, arrowroot, corn, taro and wheat) and polyphenols compounds that substantially improved the texture, chew and shelf-stability of the final product. The incorporation of polyphenols in the formulation allows for enhancements in flavor and color, and takes advantage of anti-microbial properties, as well as numerous health benefits associated with consuming polyphenols. Thus, this method and formulation provides numerous benefits for the production of starch-based foods (e.g., candies, breads, cakes, pastas, etc.).

### Examples

The previous examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### REFERENCES

1. Starch gelatinization and its complexity for analysis. Schirmer M, Jekle M, Becker T. Starch 2015. 67 30-41.
2. Adsorption of Azo dyes on Polymer Materials. V V Panic et al. Hem. Ind. 67 (6) 881-900 (2013).
3. Insights on Dietary Polyphenols as Agents against Metabolic Disorders. Aloo et al. Antioxidants. 2023 12: 416.
4. Plant polyphenols as dietary antioxidants in human health and disease. K B Pandey et al. Oxidative Medicine and Cellular Longevity 2009. 2(5): 270-278.
5. Antioxidant Activity of Spices and their Impact on Human Health: A Review. A Yashin et al. Antioxidants. 2017 Sep. 6 (3): 70.
6. The Immunomodulatory and Anti-Inflammatory Role of Polyphenols. N. Yahfoufi. Nutrients 2018 10(11): 1618.
7. Plant Polyphenols and their Potential Benefits on Cardiovascular Health: A Review. I Iqbal et al. Molecules 2023 Sep. 28(17): 6403.
8. Polyphenols and Brain Health. D Vauzour. OCL 2017. 24 (2): A202.
9. Natural Polyphenols for Prevention and Treatment of Cancer. Y. Zhou et al. Nutrients. 2016 August: 8 (8): 515.
10. Antimicrobial activity of polyphenols and natural polyphenolic extracts on clinical isolates. T Manso. Antibiotics. 2022 Jan. 11(1): 46.
11. Techniques for extraction of bioactive compounds from plant materials: A review. Azmir J, Zaidul I S M, Rahman M M. Journal of Food Engineering. 117 (2013) 426-436.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A method improving the shelf-stability of a starch-based food using Polyphenols, comprising the use of polyphenol molecules to stabilize starch gelatinization to minimize retrogradation and preserve the texture and chew of starch-based foods without the need for artificial preservatives or animal products.

2. The method of claim 1, wherein the starch-based food is a confectionary.

3. The method of claim 1, wherein the starch-based food is a bread, cake, donut, chips, pasta or noodle.

4. The method of claim 1, wherein the polyphenol molecule is a flavonoid, phenolic acid, lignan, stilbene, or tannin, or combinations thereof.

5. The method of claim 1 wherein the starch is a modified starch or unmodified starch selected from the group consisting of rice, tapioca, arrowroot, corn, potato, taro, or wheat, or combinations thereof.

6. The method of claim 1, wherein the starch-based food product is a soft chewy candy that has a room temperature shelf-life of at least 6 months.

7. The method of claim 1, wherein the polyphenol is incorporated into the starch-based food as an extract, concentrate, juice or powder obtained from the source fruit, vegetable, nut, seed or legume, lemon juice concentrate, lemon peel extract, berry juice concentrate.

8. The method of claim 1, wherein the polyphenol is incorporated into the starch-based food as a purified form of the polyphenol including. quercetin, catechin, or hesperidin concentrate powder.

9. The method of claim 1, wherein the polyphenol enhances the color, flavor, scent or texture of the starch-based food.

10. A method of making a shelf-stable soft and chewy food product using a combination of heat, pressure and mechanical stress to improve its texture, chew and shelf life.

11. The method of claim 10, wherein using high pressure extrusion cooking with a temperature between about 120° C. to about 160° C. with a pressure between about 0 to about 10 bars of pressure and mechanical stress.

12. The method of claim 10, wherein using a pressurized scraped surface heat exchanger and a single or twin-screw cooking extruder.

13. The method of claim 1, wherein the food product is covered in chocolate or other fat-based coating.

14. The method of claim 1, wherein the food product includes protein powder selected from the group consisting of whey, collagen, or plant powder including whey, casein, pea, soy, rice, chickpea.

15. A method of creating and preserving a unique texture and chewiness of starch-based chewy candy comprising: using a low molecular weight carbohydrate-based compound to improve starch gelatinization of the starch-based chewy candy and decreasing the starch retrogradation to produce a shelf-stable food product with a soft and chewy texture.

16. The method of claim 15, wherein the low molecular weight carbohydrate-based compound molecule is polyol like glycerin, sorbitol, erythritol, xylitol, mannitol, allulose, dextrose, fructose, or other polyol molecules.
